(19) United States
(12) Patent Application Publication
(10) Pub. No.: US 2010/0081041 A1
(43) Pub. Date: Apr. 1, 2010

(54) CAR BATTERY SYSTEM

(76) Inventors: Wataru OKADA, Kobe City (JP); Yasuhiro YAMAUTI, Sumoto City (JP)

Correspondence Address: WENDEROTH, LIND & PONACK, L.L.P., Suite 800, 2033 "K" Street, N.W., Washington, DC, 20006, US

(21) Appl. No.: 12/566,188

(22) Filed: Sep. 24, 2009

(30) Foreign Application Priority Data
Sep. 27, 2008 (JP) 2008-249363

(51) Int. Cl. H01M 2/24; H01M 6/46

(52) U.S. Cl. 429/82; 429/153

(57) ABSTRACT

The battery system is provided with battery blocks 2 having a plurality of stacked battery cells 1, a pair of endplates 4 stacked at opposite ends of a battery block 2, connecting rails 5 that join the pair of endplates 4, and output lines 20 that connect to battery cell 1 electrode terminals 13. Output lines 20 are connected to battery cell 1 electrode terminals 13 via transfer bus bars 22, and an output line 20 connecting terminal 21 is connected to a transfer bus bar 22 by a bolt 7, and a nut 8. In this battery system, the nut 8 is attached to an endplate 4 in a manner that does not allow it to rotate, and the bolt 7 is screwed into the nut 8 to attach it to the endplate 4. The output line 20 connecting terminal 21 and transfer bus bar 22 are connected via the bolt 7 and nut 8 and are fixed to the endplate 4.

### BACKGROUND OF THE INVENTION

1. Field of the Invention

The present invention relates to a battery system used primarily in a hybrid car or electric automobile.

2. Description of the Related Art

A battery system with many battery cells stacked together has been developed (refer to Japanese Laid-Open Patent Publication No. 2001-29896 A). By connecting battery cells in series, the battery system can produce a high output voltage and can be used in an application that charges and discharges batteries with high currents, such as in a hybrid car driving power source apparatus. In this battery system, batteries are discharged with extremely large currents during vehicle acceleration, and are charged with correspondingly high currents under conditions such as regenerative braking. Because this battery system produces large currents, output connections must be low resistance with large diameter output lines. To achieve this, output line connecting terminals are tightly connected to battery block electrode terminals with significant torque.

A battery system with a plurality of stacked battery cells uses rectangular batteries as the battery cells. A rectangular battery has electrode terminals mounted on its perimeter surface in an insulating fashion. If a bolt or set screw is tightened onto a battery cell electrode terminal with a large amount of torque, the rotational torque applies a large force on the electrode terminal. This has the danger of generating cracks in the electrode terminal connection-region, or damaging the electrode terminal such as breaking it off. If torque on the bolt or set screw is reduced to prevent damage to the electrode terminal, the output line cannot be connected to the electrode terminal with a stable, reliable low resistance connection. In particular, a battery system installed on-board an electric vehicle such as a hybrid car demands reliable low contact resistance connections at connecting terminals. This is because currents over 100A can flow through the electrode terminals of an electric vehicle battery system. Power proportional to the contact resistance times the square of the current is wasted, and that wasted power generates heat at the connection-region. Meanwhile, in a prior art battery system, if the tightening torque is increased for good output line connection, electrode terminals are easily damaged. Conversely, if the torque is reduced, electrode terminal damage can be prevented, but the connecting terminals cannot be connected with a stable, low contact resistance connection.

The present invention was developed with the object of correcting the drawbacks described above. Thus, it is a primary object of the present invention to provide a battery system that connects output line connecting terminals with stable, reliable low contact resistance connections while preventing battery cell electrode terminal damage to enable ideal output line connections.

### SUMMARY OF THE INVENTION

The battery system of the present invention is provided with battery blocks 2 made up of a plurality of stacked battery cells 1, a pair of endplates 4, 74 attached at opposite ends of a battery block 2 sandwiching the battery block 2 in the direction of the battery cell stack, connecting rails 5 that join a pair of endplates 4, 74, and output lines 20 that connect to electrode terminals 13 of battery cells 1 that make up a battery block 2. Output lines 20 are connected to battery cell 1 electrode terminals 13 via transfer bus bars 22, 72 that connect to the battery cell 1 electrode terminals 13. An output line 20 connecting terminal 21 is connected to a transfer bus bar 22, 72 by a bolt 7, 77. In this battery system, the bolt 7, 77 is attached to the endplate 4, 74, and the output line 20 connecting terminal 21 and transfer bus bar 22, 72 are connected via the bolt 7, 77 and fixed to the endplate 4, 74. The above and further objects of the present invention as well as the features thereof will become more apparent from the following detailed description to be made in conjunction with the accompanying drawings.

### BRIEF DESCRIPTION OF THE DRAWINGS

FIG. 1 is an oblique view of a battery system for one embodiment of the present invention;

FIG. 2 is a lateral cross-section view of the battery system shown in FIG. 1;

FIG. 3 is an oblique view showing the internal structure of the battery system shown in FIG. 1;

FIG. 4 is an oblique view with enlarged insets showing the battery block connecting structure for the battery system shown in FIG. 3;

FIG. 5 is an exploded oblique view showing the stacking configuration of battery cells and insulating spacers;

FIG. 6 is an exploded oblique view showing the connecting structure of an output line for the battery system shown in FIG. 3;

FIG. 7 is an enlarged cross-section view showing the connecting structure of an output line for the battery system shown in FIG. 3;

FIG. 8 is an exploded oblique view showing the connecting structure of an output line for another embodiment of the battery system of the present invention;

FIG. 9 is an enlarged cross-section view showing the connecting structure of an output line for the battery system shown in FIG. 8;

FIG. 10 is an exploded oblique view showing the connecting structure of an output line for another embodiment of the battery system of the present invention;

FIG. 11 is an enlarged cross-section view showing the connecting structure of an output line for the battery system shown in FIG. 10;

FIG. 12 is an oblique view of a battery system for another embodiment of the present invention; and

FIG. 13 is an exploded oblique view showing the connecting structure of an output line for the battery system shown in FIG. 12.

### DETAILED DESCRIPTION OF THE PREFERRED EMBODIMENT(S)

The battery system is provided with battery blocks 2 with a plurality of stacked battery cells 1, a pair of endplates 54 attached at opposite ends of a battery block 2 sandwiching the battery block 2 in the direction of the battery cell stack, connecting rails 5 that join a pair of endplates 54, and output lines 20 that connect to electrode terminals 13 of battery cells 1 that make up a battery block 2. Output lines 20 are connected to battery cell 1 electrode terminals 13 via transfer bus bars 22 that connect to the battery cell 1 electrode terminals 13. An output line 20 connecting terminal 21 is connected to a transfer bus bar 22 by a bolt 57, and a nut 58 that threads onto the bolt 57. In this battery system, the nut 58 or bolt 57 is attached to an endplate 54 in a manner that does not allow it to rotate, and the nut 58 is threaded onto the bolt 57 to attach it to the endplate 54. The output line 20 connecting terminal 21 and transfer bus bar 22 are connected via the nut 58 and bolt 57 and are fixed to the endplate 54.

The battery system is provided with battery blocks 2 with a plurality of stacked battery cells 1, a pair of endplates 64 attached at opposite ends of a battery block 2 sandwiching the battery block 2 in the direction of the battery cell stack, connecting rails 5 that join a pair of endplates 64, and output lines 20 that connect to electrode terminals 13 of battery cells 1 that make up a battery block 2. Output lines 20 are connected to battery cell 1 electrode terminals 13 via transfer bus bars 22 that connect to the battery cell 1 electrode terminals 13. An output line 20 connecting terminal 21 is connected to a transfer bus bar 22 by a set screw 67. In this battery system, the endplate 64 is provided with a screw-hole 68 that accepts the set screw 67 to attach the output line 20 connecting terminal 21 to the transfer bus bar 22. The set screw 67 screws into the screw-hole 68 to attach it to the endplate 64, and the output line 20 connecting terminal 21 and transfer bus bar 22 are connected via the set screw 67 and the endplate 64.

The battery system described above has the characteristic that it connects output line connecting terminals with stable, reliable low contact resistance connections while preventing battery cell electrode terminal damage to enable ideal output line connections. This is because torque applied to tighten the bolt and nut that connect an output line does not apply excessive rotational torque on an electrode terminal. Although the transfer bus bar is connected to an electrode terminal in this battery system, it can be connected to a battery cell electrode terminal while bolted to the endplate. Consequently, when the transfer bus bar is connected to the electrode terminal, the electrode terminal is not damaged by rotational torque.

Further, since the nut can be attached to the endplate in a manner that does not allow it to rotate, the transfer bus bar is not rotated by torque applied to screw in the bolt, and the transfer bus bar does not apply excessive force to the electrode terminal. In addition, since the bolt can be attached to the endplate in a manner that does not allow it to rotate and the nut can be threaded onto the bolt to connect the connecting terminal, the transfer bus bar is not rotated by torque applied to the nut, and the transfer bus bar does not apply excessive force to the electrode terminal. Still further, the endplate can be provided with a screw-hole to attach the output line connecting terminal to the endplate with a set screw, and the set screw is screwed into the screw-hole to connect the output line to the transfer bus bar. Consequently, torque on the set screw does not rotate the transfer bus bar, and excessive force is not applied to the electrode terminal by set screw torque.

In the battery system, an output line 20 connecting terminal 21 is a round terminal having a through-hole 21A to insert a bolt or set screw 7, 57, 67, 77. The transfer bus bar 22, 72 is provided with through-holes 22A, 72A to insert bolts or set screws 7, 57, 67, 77. A bolt or set screw 7, 57, 67, 77 is inserted through a connecting terminal 21 through-hole 21A and through a transfer bus bar 22, 72 through-hole 22A, 72A, the end of the bolt or set screw 7, 57, 67, 77 is screwed into a nut 8, 58, 78 or into the endplate 64, and the transfer bus bar 22, 72 and connecting terminal 21 are sandwiched in between for connection. In this battery system, a bolt is inserted through through-holes in the transfer bus bar and connecting terminal and the bolt is screwed into a nut for attachment, or a set screw is attached to an endplate. Therefore, the output line connecting terminal and transfer bus bar can be reliably connected.

Battery cells 1 that make up a battery block 2 of the battery system can have electrode terminals 13 disposed at an inclined angle with respect to the electrode surface 10. A battery cell with electrode terminals mounted at an inclined angle with respect to the electrode surface can easily be interconnected with adjacent battery cells. However, if excessive force is applied to an electrode terminal due to torque applied to tightly attach a connecting terminal to the electrode terminal, the force is applied to the electrode terminal to pull it away from the battery cell perimeter surface or push it into the perimeter surface. Electrode terminals mounted on an electrode surface are easily damaged by forces in these directions. However, in the battery system described above, since excessive force is not applied to an electrode terminal by the output line connection, adjacent battery cell electrode terminals can be efficiently connected while preventing electrode terminal damage.

In the battery system, endplates 74 can be provided with duct-plate sections 74Y for air ducts 33 established to ventilate battery block 2 battery cells 1 with cooling air, and bolts 77 can be attached to those duct-plate sections 74Y. In this battery system, since a bolt can be attached to a duct-plate section provided at an endplate, the duct-plate section designed for battery cell cooling can serve a dual purpose as a connecting terminal attachment point, and this has the characteristic that the connecting terminal can be reliably connected.

The following describes embodiments based on the figures. The battery system is most appropriately used as a power source for an electric driven vehicle such as a hybrid car, which is driven by both an electric motor and an engine, or an electric automobile, which is driven by an electric motor only. However, the battery system can also be used in a vehicle other than a hybrid car or electric automobile, or in an application other than automotive that demands large output.

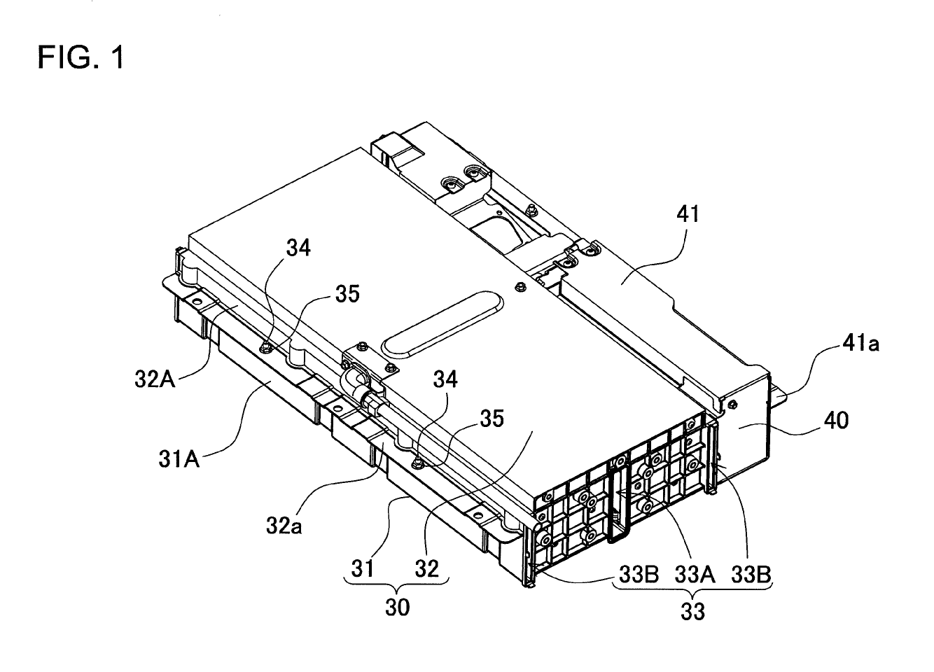

The battery system of FIGS. 1-7 is provided with battery blocks 2 with a plurality of stacked battery cells 1, a pair of endplates 4 attached at opposite ends of a battery block 2 sandwiching the battery block 2 in the direction of the battery cell stack, connecting rails 5 that join a pair of endplates 4, and output lines 20 that connect to electrode terminals 13 of battery cells 1 that make up a battery block 2.

Further, in the battery system of the figures, an output line 20 is not directly connected to a battery cell 1 electrode terminal 13, but rather is connected to the electrode terminal 13 via a transfer bus bar 22. The output line 20 is connected to the transfer bus bar 22 by a bolt 7 and a nut 8 that is screwed onto the bolt 7.

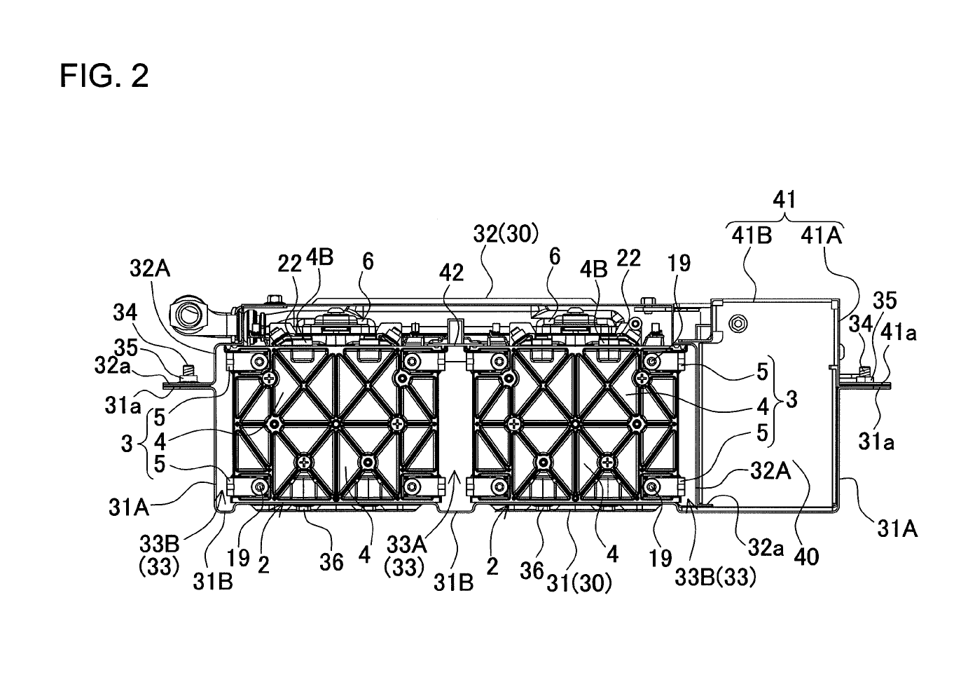

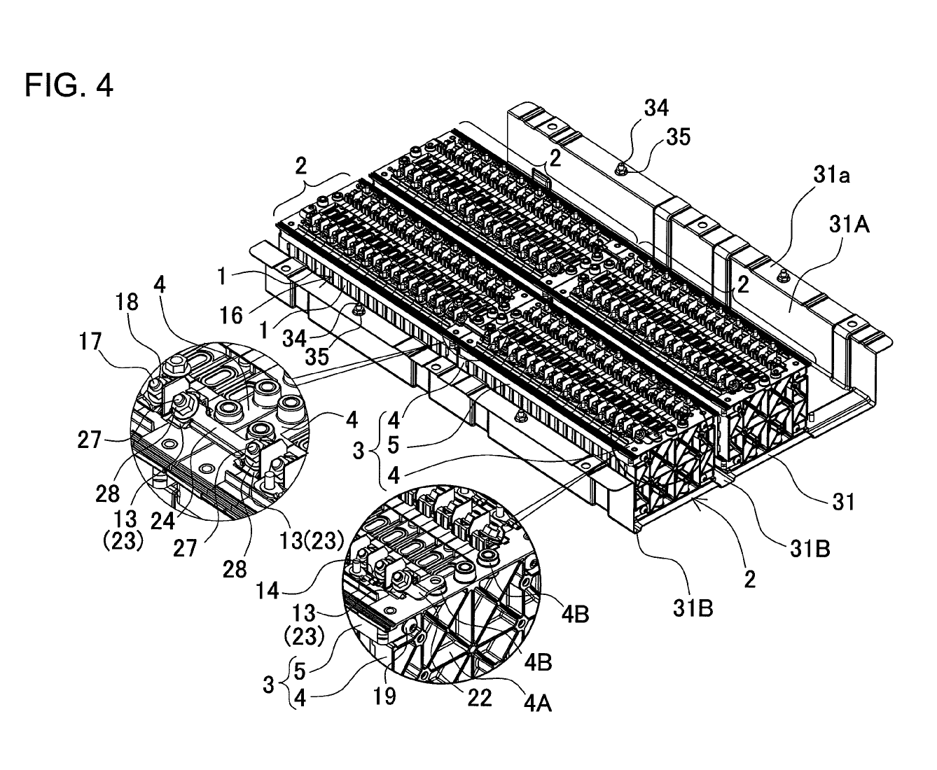

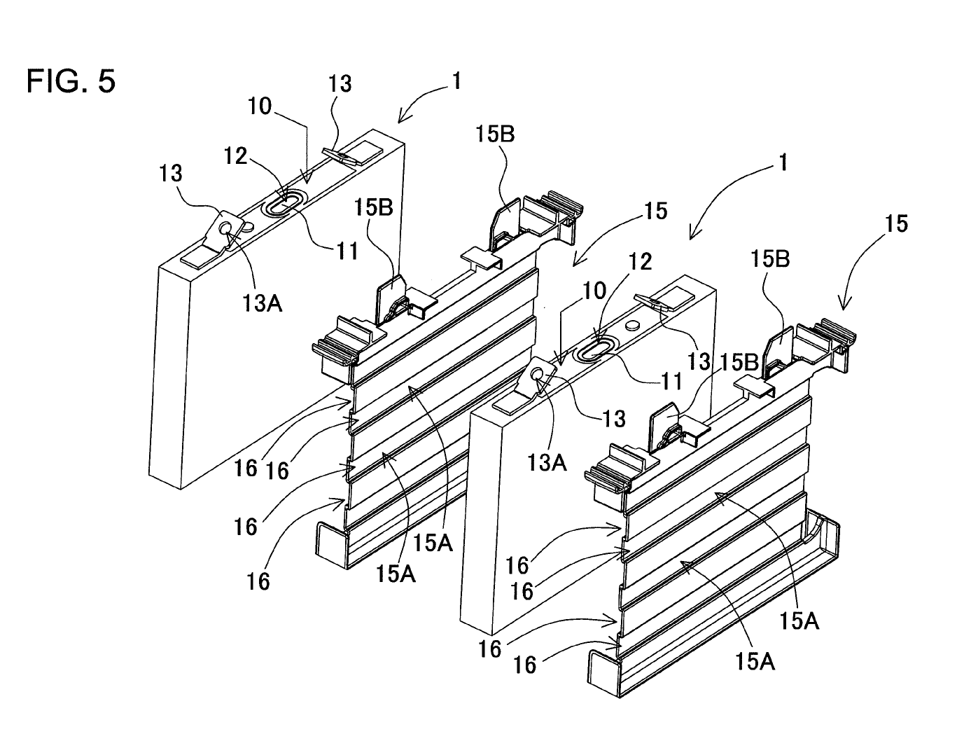

Battery cells 1 are stacked with electrode surfaces 10, which are provided with positive and negative electrode terminals 13, as a common upper surface shown in FIGS. 4 and 5. To insulate adjacent battery cells 1, insulating spacers 15 are sandwiched between battery cells 1. A battery cell 1 of the figures is provided with positive and negative electrode terminals 13 at the ends of the electrode surface 10, and a gas exhaust opening 12 for a gas exhaust valve 11 at the center of the electrode surface 10. As shown in FIG. 2, a hollow gas exhaust duct 6 to exhaust gas discharged from the gas exhaust openings 12 is disposed at the center of the electrode surfaces 10 of a battery block 2 extending in the battery cell stacking direction. The gas exhaust duct 6 exhausts gas to the outside when it is discharged from battery cell 1 gas exhaust valves 11.

As shown in FIG. 5, a battery cell 1 is wide compared to its thickness. These rectangular battery cells, which are thinner than they are wide, are stacked in the direction of their thin dimension to form a battery block 2. The battery cells 1 are lithium-ion rechargeable batteries. However, the battery cells can also be rechargeable batteries such as nickel-hydride batteries or nickel-cadmium batteries. The battery cells 1 of the figure are rectangular-shaped with wide surfaces on both sides, and those side surfaces are stacked against one another to form a battery block 2.

When the internal pressure of a battery cell 1 becomes greater than a set pressure, the gas exhaust valve 11 opens to prevent excessive internal pressure rise. The gas exhaust valve 11 houses a valve mechanism (not illustrated) that closes off the gas exhaust opening 12. The valve mechanism has a membrane that breaks at a set pressure, or it is a valve with a flexible component that presses against a valve seat and opens at a set pressure. When the gas exhaust valve 11 is opened, the interior of the battery cell 1 is opened to the outside through the gas exhaust opening 12, and the gas inside is exhausted to prevent internal pressure build-up.

Adjacent battery cells 1 have their positive and negative electrode terminals connected to connect the battery cells 1 in series. In the battery system of the figures, positive and negative electrode terminals 13 of adjacent battery cells 1 are connected in series via bus bars 14. Electrode terminals 13 joined by bus bars 14 are connected by bolts 17 and nuts 18. The battery system of the figures has battery cell 1 electrode terminals 13 disposed at an inclined angle with respect to the electrode surface 10. The electrode terminals 13 of the figures are inclined at an angle of approximately 45° with respect to the electrode surface 10. In these battery cells 1, bolts 17 are easily inserted from beneath the electrode terminals 13, and nuts 18 can be threaded on from above for attachment. A battery system with adjacent battery cells 1 connected in series can produce a high output voltage. However, the battery system can also connect adjacent battery cells in parallel.

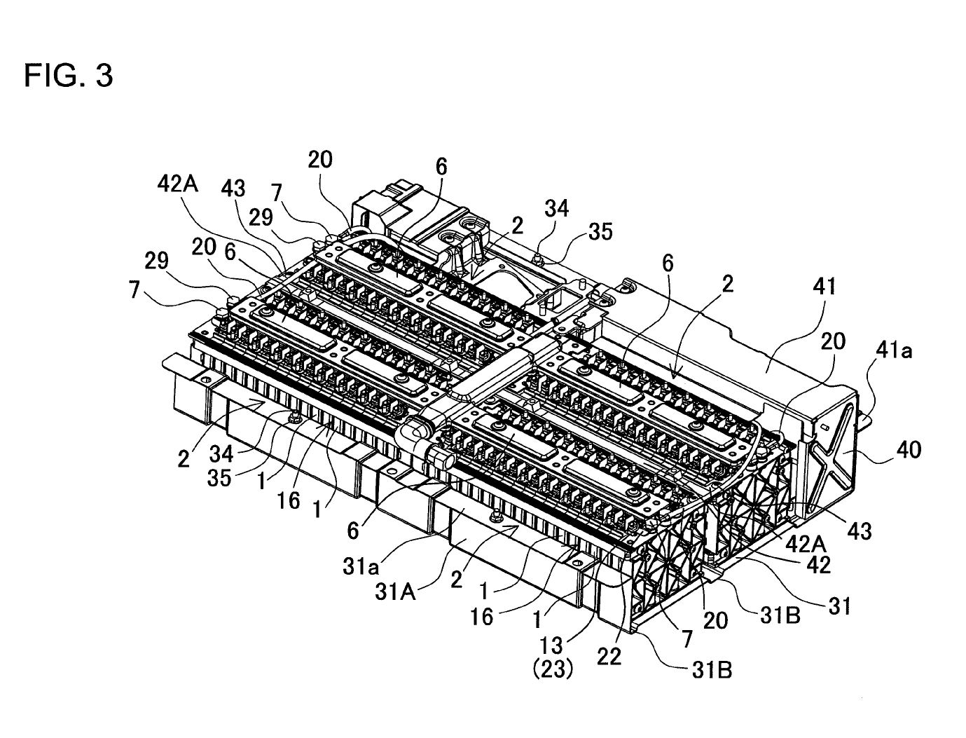

The battery block 2 shown in FIGS. 3-5 has insulating spacers 15 sandwiched between stacked battery cells 1. The insulating spacers 15 insulate adjacent battery cells 1. In addition, the insulating spacers 15 of the figures are provided with insulating walls 15B that project outward between adjacent electrode terminals 13. As shown in FIG. 5, an insulating spacer 15 has a shape that fits battery cells 1 in fixed positions on both sides, and allows adjacent battery cells 1 to be stacked without shifting position. Battery cells 1 stacked in an insulating manner with insulating spacers 15 can have external cases made of metal such as aluminum. In a configuration that sandwiches insulating spacers 15 between battery cells 1, the insulating spacers 15 can be fabricated from low heat conductivity material such as plastic to achieve the additional result of effectively preventing thermal runaway of adjacent battery cells 1. However, a plurality of battery cells can be stacked without intervening spacers by insulating battery cell external case surfaces by covering them with an insulating film. In this case, plastic heat-shrink tubing or insulating coating can be used as an insulating film. In this battery block, battery cells can be effectively cooled from the bottom or top surfaces with a configuration that cools battery cell bottom or top surfaces with cooling pipes.

Insulating spacers 15 stacked with the battery cells 1 are provided with cooling gaps 16 between the insulating spacers 15 and the battery cells 1 to pass a cooling gas such as air to effectively cool the battery cells 1. The insulating spacers 15 of FIG. 5 are provided with grooves 15A in their surfaces opposite the battery cells 1 that extend to the edges on both sides and establish cooling gaps 16 between the insulating spacers 15 and the battery cells 1. The insulating spacers 15 of the figure are provided with a plurality of grooves 15A having parallel orientation and disposed at given intervals. The insulating spacers 15 of the figure are provided with grooves 15A on both sides to establish cooling gaps 16 between insulating spacers 15 and adjacent battery cells 1. This structure has the characteristic that battery cells 1 on both sides of an insulating spacer 15 can be effectively cooled by cooling gaps 16 formed on both sides of the insulating spacer 15. However, grooves can also be provided on only one side of an insulating spacer to establish cooling gaps between battery cells and insulating spacers. The cooling gaps 16 of the figures are established extending in a horizontal direction and opening on the left and right sides of the battery block 2. Ventilating air passed through the cooling gaps 16 efficiently cools battery cell 1 external cases by direct contact. This configuration has the characteristic that battery cells 1 can be efficiently cooled while effectively preventing battery cell 1 thermal runaway.

Stacked battery cells 1 of a battery block 2 are held in a battery holder 3 made up of a pair of endplates 4 and connecting rails 5 that join the pair of endplates 4.

The endplates 4 have a rectangular shape with the same dimensions and shape as the outline of the battery cells 1, and the endplates 4 hold the stacked battery block 2 from both ends. An endplate 4 is made of plastic and is provided with reinforcing ribs 4A extending vertically and horizontally on the outer surface, which is formed as a single piece with the endplate 4. Endplates 4 can be reinforced by attaching reinforcing metal pieces. In addition, connecting rails can be attached to the reinforcing metal pieces. This configuration has the characteristic that endplates reinforced with reinforcing metal pieces can make robust structures, and connecting rails can be solidly connected to the endplates. In particular, this configuration has the characteristic that it can make the endplates themselves strong when the endplates are molded from plastic. However, endplates do not always need to be reinforced with reinforcing metal pieces.

Connecting rails 5 are made of metal such as steel, and both ends and possibly the middle (when more than one battery block is included) are attached to endplates 4 via set screws 19.

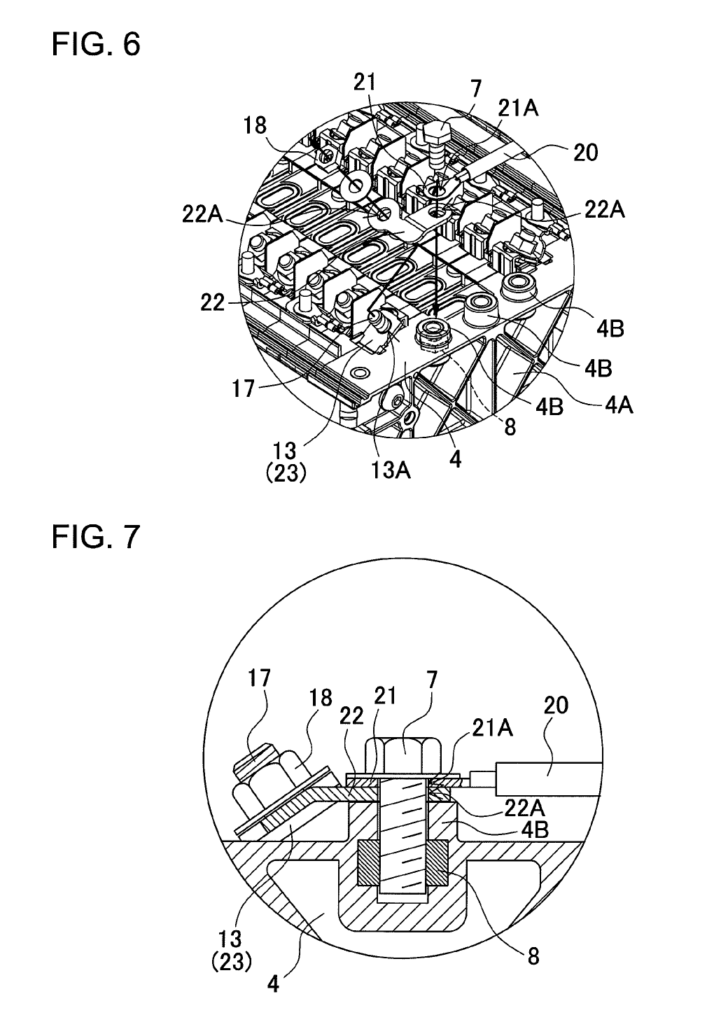

An endplate 4 has a nut 8 mounted in a manner that does not allow it to rotate. The nut 8 is insertion molded and fixed in an endplate 4 during formation of the plastic endplate 4. However, a cavity can also be formed in an endplate in which the nut can fit without rotating, and the nut can be fit into that cavity and attached without rotating. In the endplate 4 of FIGS. 6 and 7, boss protrusions 4B, which project out from the upper surface, are formed as a single piece with the endplate 4, and nuts 8 are insertion molded inside those boss protrusions 4B. The endplate 4 of the figures is provided with three sets of boss protrusions 4B, and a nut 8 is insertion molded into each boss protrusion 4B. In this endplate 4, a bolt 29 to attach a gas exhaust duct 6 is screwed into the nut 8 in the center boss protrusion 4B, and transfer bus bars and output line 20 connecting terminals 21 can be attached by screwing bolts 7 into nuts 8 mounted in boss protrusions 4B on both sides.

The battery system of FIGS. 3 and 4 has four battery blocks 2 disposed in two rows and two columns. The four battery blocks 2 of this battery system are connected in series. As shown in the inset enlargement of FIG. 4, each row of battery blocks 2 is connected in series via jumper bus bars 24. Both ends of a jumper bus bar 24 are attached to battery cell 1 electrode terminals 13 of adjacent battery blocks 2 via bolts 27 and nuts 28. A jumper bus bar 24 is a metal plate provided with through-holes at both ends. Electrode terminals 13 are also provided with through-holes. A bolt 27 is inserted through the through-holes of the jumper bus bar 24 stacked on an electrode terminal 13, and a nut 28 is threaded on to connect the jumper bus bar 24 to the electrode terminal 13. Although jumper bus bars 24 are not attached to endplates 4 in the battery system of the figures, the middle of a jumper bus bar can also be attached to an endplate. A jumper bus bar that is attached to an endplate has a through-hole provided at its mid-region. The through-hole provided at the mid-region of the jumper bus bar is located at the insertion point for a bolt that attaches the jumper bus bar to the endplate. For example, the through-hole is provided at a location on the upper surface of a boss protrusion. This jumper bus bar can be attached to an endplate by screwing a bolt inserted in the through-hole into a nut mounted in the endplate.

Each battery block 2 has a positive and negative output terminal 23. Battery block 2 output terminals 23 are battery cell 1 electrode terminals 13 disposed at both ends of the battery block 2. The battery system of FIG. 4 has two rows of battery blocks 2 that are connected in series by jumper bus bars 24. Therefore, each battery block 2 has one output terminal 23 connected to a jumper bus bar 24 and the other output terminal 23 connected to an output line 20. The electrode terminal 13 connected to the output line 20, which is an output terminal 23, is connected to the output line 20 via a transfer bus bar 22.

As shown in FIGS. 3 and 6, one end of a transfer bus bar 22 is connected to a battery cell 1 electrode terminal 13, which is an output terminal 23, and the other end is connected to an output line 20. As shown in FIG. 6, a transfer bus bar 22 is a metal plate with through-holes 22A provided at both ends. To facilitate stacking and connection on an electrode terminal 13, which is disposed at an inclined angle, the transfer bus bar 22 of the figures has its end that is connected to the electrode terminal 13 bent at an inclined angle. The transfer bus bar 22 has one end stacked on, and connected to an electrode terminal 13 (output terminal 23), and the other end has a shape allowing it to connect to a nut 8 mounted in an endplate 4. The transfer bus bar 22 is bent to a shape allowing one end to be stacked on top of the electrode terminal 13 and the other end to be stacked on top of a boss protrusion 4B with a nut 8 mounted inside. In addition, the transfer bus bar 22 is provided with through-holes 22A that coincide with the location of the electrode terminal 13 through-hole 13A and with the location of the nut 8.

An output line 20 has a connecting terminal 21 attached to its end. A connecting terminal 21 is a metal plate having a through-hole 21A, and specifically, is a round terminal, which is attached by crimping onto the output line 21 wire-lead. The output line 20 connecting terminal 21 is stacked on top of a transfer bus bar 22, and a bolt 7 inserted through the connecting terminal 21 through-hole 21A and the transfer bus bar 22 through-hole 22A is fastened to the endplate 4. As shown in FIG. 7, the bolt 7 is screwed into the nut 8 to connect the output line 20 connecting terminal 21 stacked on the transfer bus bar 22 and fasten that connection to the endplate 4. Since the nut 8 is mounted in the endplate 4 in a manner that does not allow rotation, the connecting terminal 21 is retained with the bolt 7 and nut 8 tightened in a manner that does rotate. Therefore, rotational torque applied to tighten the bolt 7 does not cause rotation of the transfer bus bar 22.

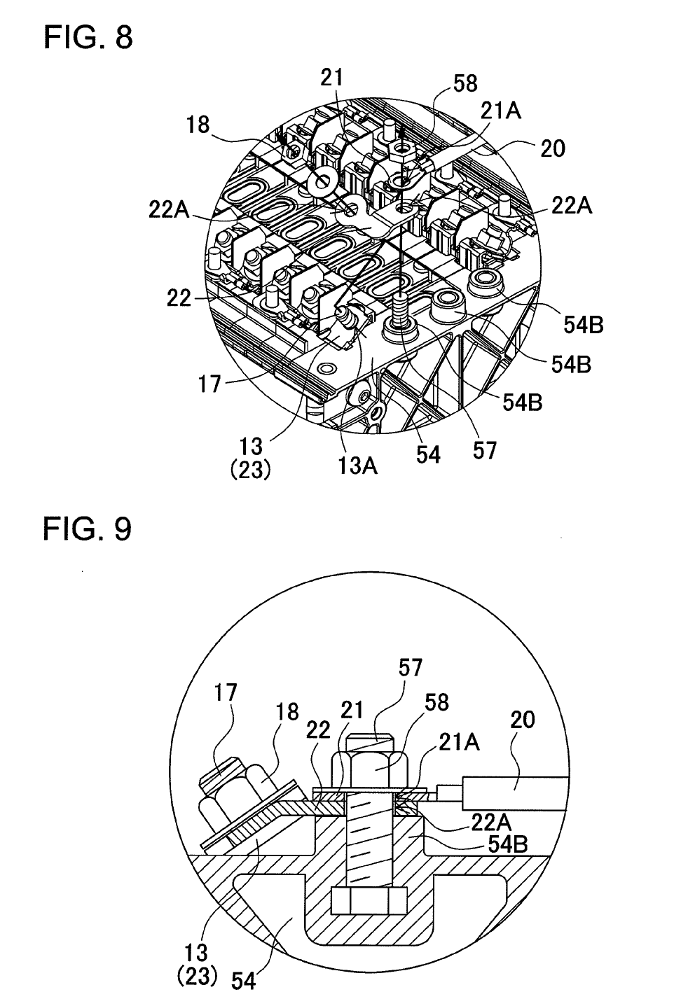

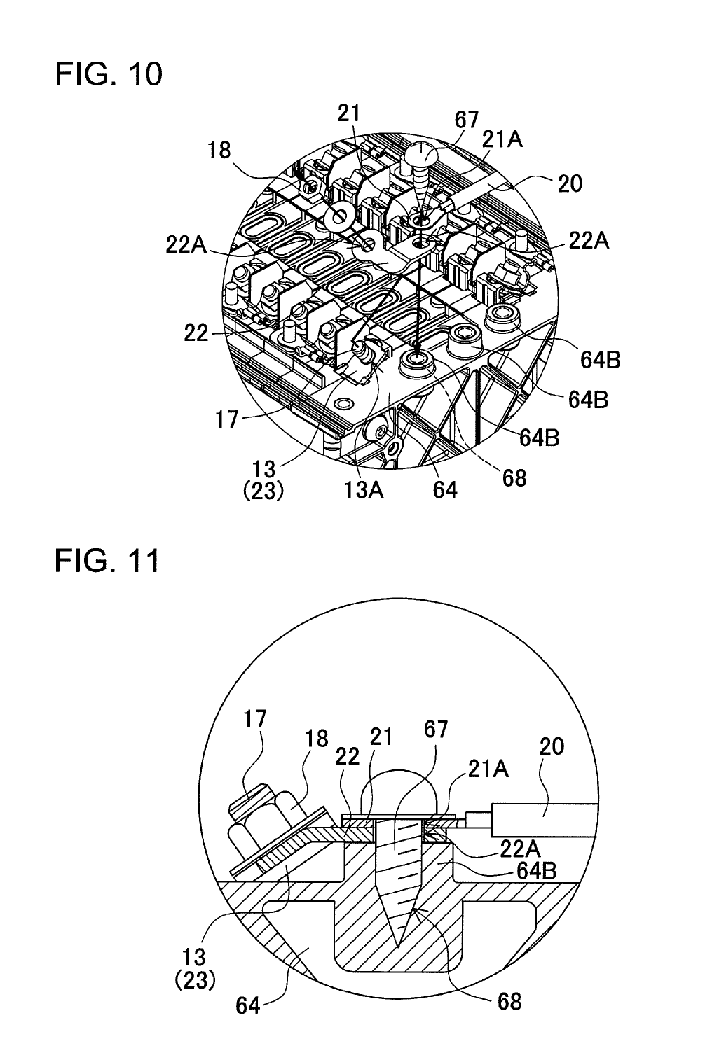

In the battery system described above, a nut 8 is mounted in an endplate 4 in a manner that does not allow rotation. As shown in FIGS. 8 and 9, the battery system can also have a bolt mounted in the endplate instead of a nut. A bolt 57 is insertion molded into a boss protrusion 54B, which is formed as a single piece with the endplate 54. The bolt 57 is mounted in the endplate 54 with its threaded region projecting upward from the endplate 54. This structure allows a nut 58 to be threaded onto the bolt 57 to connect an output line 20 connecting terminal 21 to a transfer bus bar 22 and to the endplate 54. The bolt 57 that the nut 58 is tightened onto passes through the transfer bus bar 22 through-hole 22A and the output line 20 connecting terminal 21 through-hole 21A with the connecting terminal 21 stacked on top of the transfer bus bar 22. Specifically, the transfer bus bar 22 and output line 20 connecting terminal 21 are stacked on top of the boss protrusion 54B in a manner inserting the bolt 57 mounted inside the boss protrusion 54B through each through-hole 22A, 21A. In this state, the nut 58 is threaded onto the bolt 57 to connect the connecting terminal 21 to the transfer bus bar 22, and attach the connected unit to the endplate 54. When the nut 58 is tightened onto the bolt 57, the connecting terminal 21 is retained in a manner that does not rotate. With this structure as well, the output line 20 connecting terminal 21 is connected to a battery block 2 output terminal 23, namely to an electrode terminal 13, via the transfer bus bar 22.

Further, in the battery system of the present invention, a set screw 67 can be screwed into a boss protrusion 64B for attachment without using a nut. The set screw 67 is a self-tapping screw that can be screwed into, and attached to an endplate 64 boss protrusion 64B. The self-tapping set screw 67 screws into the boss protrusion 64B and establishes a screw-hole 68. The set screw 67 is attached to the endplate 64 when it is screwed into the screw-hole 68. The endplate 64 is provided with a boss protrusion 64B formed as a single piece with the endplate 64. The boss protrusion 64B allows a set screw 67 to be screwed in for attachment. In this structure, the self-tapping set screw 67 is screwed into the boss protrusion 64B to connect the output line 20 connecting terminal 21 to the transfer bus bar 22, and attach them to the endplate 64. The self-tapping set screw 67 is inserted through the output line 20 connecting terminal 21 through-hole 21A and the transfer bus bar 22 through-hole 22A and screwed into the boss protrusion 64B. With the set screw 67 screwed in, the transfer bus bar 22 is stacked on top of the boss protrusion 64B, and the connecting terminal 21 is stacked on top of the transfer bus bar 22. The transfer bus bar 22 and output line 20 connecting terminal 21 are stacked on top of the boss protrusion 64B in a manner that passes the set screw 67 through each through-hole 22A, 21A. The self-tapping set screw 67 is inserted through the connecting terminal 21 through-hole 21A and through the transfer bus bar 22 through-hole 22A and screwed in to the endplate 64 for attachment. When the set screw 67 is tightened, the connecting terminal 21 is retained in a manner that does not rotate. With this structure as well, the output line 20 connecting terminal 21 is connected to a battery block 2 output terminal 23, namely to an electrode terminal 13, via the transfer bus bar 22.

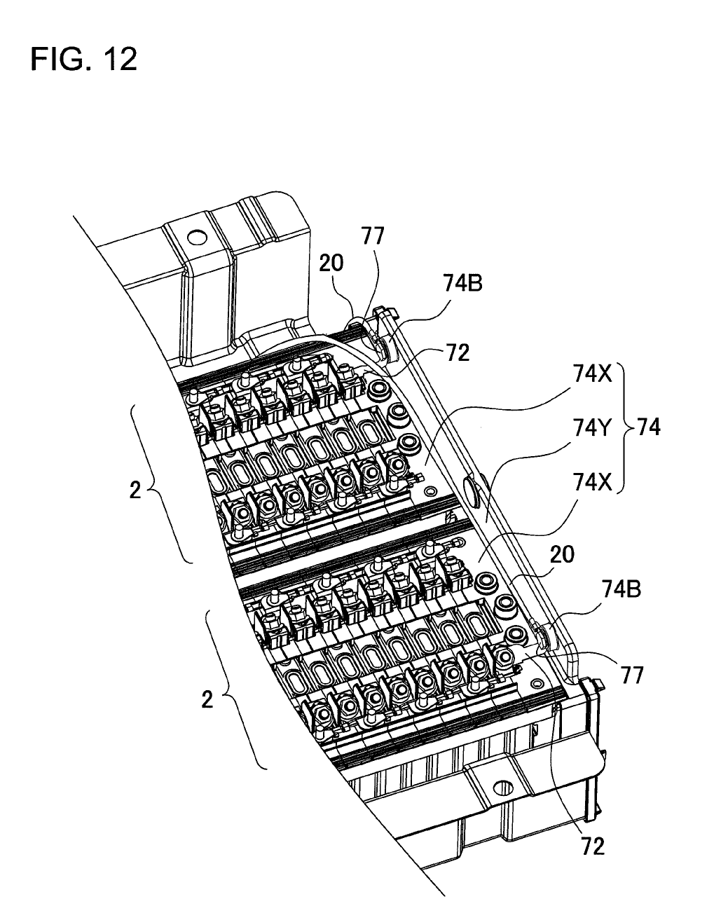

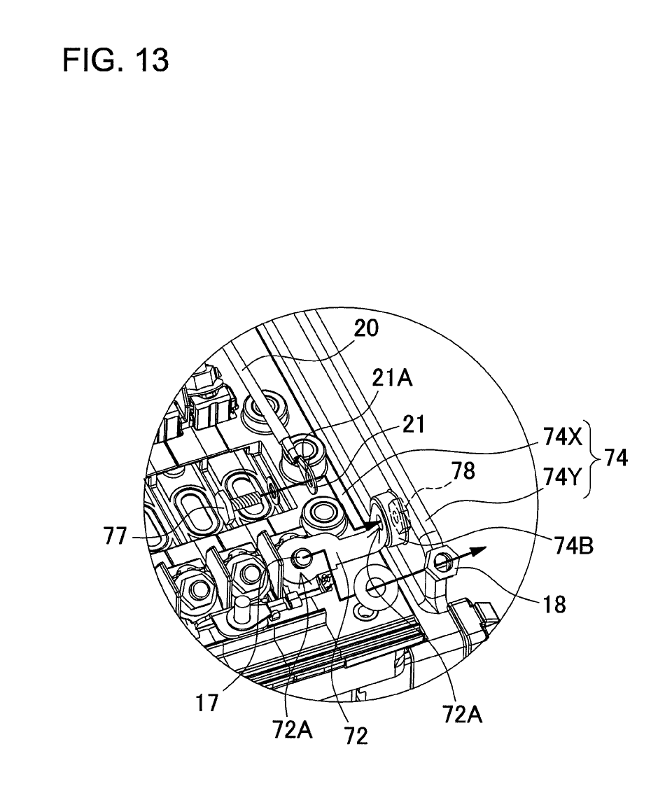

Further, the endplate 74 of FIGS. 12 and 13 is provided with a duct-plate section 74Y that establishes air ducting for forced air ventilation of battery block 2 battery cells 1. The duct-plate section 74Y is attached to the main body 74X of an endplate 74, and the duct-plate section 74Y is formed as a separate piece from the main body 74X of the endplate 74. This configuration allows the main body 74X of the endplate 74 to be made of metal and the duct-plate section 74Y to be made of plastic for a robust endplate 74 structure. In the same fashion as the plastic endplates 4, 54 previously described, the duct-plate section 74Y has nuts or bolts mounted in a manner that does not allow rotation. The endplate 74 of the figures has nuts 78 inserted in the duct-plate section 74Y. A bolt 77 inserted through a connecting terminal 21 through-hole 21A and a transfer bus bar 72 through-hole 72A is screwed into a nut 78 to connect the output line 20 connecting terminal 21 to the transfer bus bar 72.

In this battery system, the endplate 74 is divided into a main body 74X and a duct-plate section 74Y, and the transfer bus bar 72 and output line 20 connecting terminal 21 are attached to the duct-plate section 74Y. The attachment configuration of the transfer bus bar 72 and the connecting terminal 21 can be the same as the previously described attachment structure for a plastic endplate 4, 54, 64. However, the endplate 74 of the figures has a duct-plate section 74Y provided with horizontally projecting boss protrusions 74B on a vertical surface. Therefore, the end of a transfer bus bar 72 is bent to conform to the surface of the boss protrusion 74B. Even in a battery system with an endplate divided into a main body and a duct-plate section, the transfer bus bar and connecting terminal can be attached via a bolt to the top surface of the duct-plate section to project in a vertical direction. Specifically, even for an endplate divided into a main body and a duct-plate section, the attachment structure can be the same as for previously described endplates 4, 54, 64 formed entirely from plastic.

In the endplate 74 of FIGS. 12 and 13, nuts 78 or bolts 77 can be insertion molded into the duct-plate section 74Y when it is formed from plastic, or cavities can be provided that fit nuts or bolts in a manner preventing rotation, and nuts or bolts can be attached in those cavities. The duct-plate section 74Y of the figures has boss protrusions 74B projecting from its surface, and nuts 78 or bolts are insertion molded into those boss protrusions 74B. In addition, self-tapping set screws can also be screwed into the boss protrusions to attach transfer bus bars and output line connecting terminals.

The battery system shown in FIGS. 1-4 has battery blocks 2 housed in an outer case 30. The outer case 30 of the figures is made up of an upper case 32 and a lower case 31. The battery system has a plurality of battery blocks 2 arranged in rows and columns and mounted in the outer case 30. The battery system shown in the oblique view of FIG. 3 has two rows of two battery blocks 2 arranged in a straight line to dispose four battery blocks 2 on the lower case 31. The two rows of battery blocks 2 are disposed with separation to establish an air duct 33 between them.

The upper case 32 and lower case 31 are sheet metal formed in U-shapes. The upper case 32 and lower case 31 are made from sheet metal of the same thickness, or the lower case 31 is made from thicker sheet metal than the upper case 32. The upper case 32 and lower case 31 are provided with side-walls 32A, 31A that establish their U-shapes. In the battery system of FIG. 3, the lateral width of the lower case 31 is greater than that of the upper case 32, and an electronic component case 40 is disposed between a lower case 31 side-wall 31A and an upper case 32 side-wall 32A. The lower case 31 has a lateral width that is greater than the upper case 32 lateral width by the width of the electronic component case 40. Specifically, the lateral width of the lower case 31 is equal to the lateral width of the upper case 32 plus the width of the electronic component case 40.

As shown in FIGS. 2 and 3, the lower case 31 side-wall 31A on the left side is attached to the upper case 32 side-wall 32A on the left side. The upper case 32 side-wall 32A on the right side is attached to the bottom section of the lower case 31, and divides the battery block 2 storage area from the electronic component case 40. The upper case 32 side-wall 32A on the right side is made taller than the side-wall 32A on the left side to enable attachment of its lower edge to the bottom section of the lower case 31. The edges of lateral extremities of both the upper case 32 and the lower case 31 are provided with outward bent flanges 32a, 31a for case attachment. Flanges 32a, 31a are attached by nuts 35 and bolts 34 that pass through the flanges 32a, 31a, or the flanges are attached by rivets to join the upper case 32 and the lower case 31.

In the battery system shown in FIGS. 2-4, the lower case 31 is provided with side-walls 31A of approximately the same height on both sides. In the figures, the lower case 31 side-wall 31A on the left side is attached to the upper case 32 side-wall 32A on the left side. The lower case 31 side-wall 31A on the right side is not attached to the upper case 32 side-wall 32A, but rather is attached to an attachment plate 41 side-wall 41A of the electronic component case 40, which is mounted on the upper case 32. The upper case 32 is also provided with side-walls 32A on both sides. In the figures, the upper case 32 side-wall 32A on the right side is longer than the side-wall 32A on the left side, the shorter side-wall 32A is attached to the lower case 31 side-wall 31A on the left side, and the longer side-wall 32A on the right side is attached to the bottom section of the lower case 31.

In the figures, the electronic component case 40 attachment plate 41 is attached to the upper end of the right side-wall 32A of the upper case 32. This attachment plate 41 is sheet metal formed in an L-shape and provided with a top plate 41B and a side-wall 41A on one side. The edge of the top plate 41B of the attachment plate 41 is attached to the upper edge of the upper case 32 side-wall 32A. A flange 41a provided on the bottom edge of the side-wall 41A is attached to the a flange 31a provided on the upper edge of the lower case 31 side-wall 31A on the right side. Flanges 41a, 31a are attached by nuts 35 and bolts 34 that pass through the flanges 41a, 31a, or the flanges are attached by rivets to join the attachment plate 41 and the lower case 31. In this outer case 30 configuration, the side-wall 32A provided on the right side of the upper case 32 separates the battery block 2 storage area and the electronic component case 40.

The outer case 30, which is made up of the upper case 32 and the lower case 31, is made wider than the outer sides of the battery blocks 2 to allow room for air ducts 33. In the battery system of FIGS. 1-4, an air duct 33 is provided at the center between the two rows of battery blocks 2, and air ducts 33 are also provided between the outside of the battery blocks 2 and the side-walls 32A, 31A. In this battery system, either the center air duct 33A between the two rows of battery blocks 2 or the pair of side air ducts 33B on the outside of the battery blocks 2 is used as a cooling air supply duct, and the other duct or pair of ducts is used as an exhaust duct. Cooling air is passed through the cooling gaps 16 between battery cells 1 to cool the battery cells 1.

The battery system shown in the cross-section of FIG. 2 is provided with a side air duct 33B between an outer side (the right side in FIG. 2) of the battery blocks 2 and an upper case 32 side-wall 32A. The electronic component case 40 housing electronic components is disposed outside the upper case 32 side-wall 32A, which is outside the side air duct 33B and forms a wall of the side air duct 33B. In this structure, a side air duct 33B and side-wall 32A are provided between the electronic components (not illustrated) housed in the electronic component case 40 and the battery blocks 2. In this configuration, the battery blocks 2 do not heat the electronic components, and detrimental effects on the electronic components due to heat generated by the battery blocks 2 can be prevented.

The open top of the center cooling duct 33A established between the two rows of battery blocks 2 is closed off by a cooling duct sealing plate 42, and the open bottom of the center cooling duct 33A is closed off by the lower case 31. The cooling duct sealing plate 42 is a narrow metal plate that extends along the center cooling duct 33A established between the two battery block 2 rows. The cooling duct sealing plate 42 is attached on both sides to battery blocks 2 to close off the open top of the center cooling duct 42. The cooling duct sealing plate 42 is attached with set screws 43 to the end-plates 4 of battery blocks 2 disposed on both sides. The cooling duct sealing plate 42 is provided with projections 42A on both sides for attachment to the end-plates 4, and the projections 42A are provided with through-holes for insertion of set screws 43. The cooling duct sealing plate 42 of FIG. 3 is provided with projections 42A on both sides at both ends and on both sides at two intermediate locations for attachment to the battery blocks 2.

In the outer case 30 described above, the lower case 31 is attached to endplates 4 via set screws 36 to attach the battery blocks 2. Set screws 36 pass through the lower case 31 and screw into screw-holes (not illustrated) in the endplates 4 to mount the battery blocks 2 in the outer case 30. The heads of these set screws 31 protrude out from the bottom of the lower case 31. Further, the lower case 31 is provided with projections 31B that protrude downward from both sides of the battery blocks 2. These projections 31B widen the air ducts 33 to reduce pressure losses in those ducts. These projections 31B also reinforce the lower case 31 and increase the bending strength of the lower case 31. Further, the projections 31B provided on bottom surface of the lower case 31 extend below the heads of the set screws 36 that attach the battery blocks 2, or they extend to the same height as the heads of the set screws 36. For a battery system with this type of lower case 31 installed on-board a car, the projections 31B set on a car attachment plate allowing battery system weight to be distributed and supported over a wide area.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2008-249363 filed in Japan on Sep. 27, 2008, the content of which is incorporated herein by reference.

What is claimed is:

1. A battery system comprising:
battery blocks having a plurality of stacked battery cells;
a pair of endplates attached at opposite ends of the battery block sandwiching the battery block in the direction of the battery cell stack;
connecting rails that join the pair of endplates; and
output lines that connect to electrode terminals of the battery cells that make up the battery block;
wherein the output line is connected to the battery cell electrode terminal via a transfer bus bar that connects to the battery cell electrode terminal, and the end of the output line is provided with a connecting terminal that connects with the transfer bus bar;
a bolt attaches the output line connecting terminal to the endplate, and the bolt connects the output line connecting terminal to the transfer bus bar and attaches the connecting terminal and transfer bus bar to the endplate.

2. The battery system as cited in claim 1 wherein a nut is provided that threads onto the bolt, the nut is attached to the endplate in a manner that does not allow it to rotate, the bolt screws into the nut to attach to the endplate, and the transfer bus bar and output line connecting terminal are connected by the bolt and nut and attached to the endplate.

3. The battery system as cited in claim 2 wherein the nut is attached to the endplate by insertion molding.

4. The battery system as cited in claim 3 wherein the endplate is provided with boss protrusions that project out from the surface and are formed as a single piece with the endplate, and nuts are insertion molded in those boss protrusions.

5. The battery system as cited in claim 1 wherein a nut is provided that threads onto the bolt, the bolt is attached to the endplate in a manner that does not allow it to rotate, the nut threads onto the bolt to attach to the endplate, and the transfer bus bar and output line connecting terminal are connected by the nut and bolt and attached to the endplate.

6. The battery system as cited in claim 5 wherein the bolt is attached to the endplate by insertion molding.

7. The battery system as cited in claim 5 wherein the endplate is provided with boss protrusions formed as a single piece with the endplate, bolts are insertion molded in those boss protrusions, bolts are fixed in the endplate with threaded regions projecting out, and a nut is threaded onto a bolt to connect the output line connecting terminal to the transfer bus bar and attach them to the endplate.

8. The battery system as cited in claim 1 wherein the endplate has a screw-hole that accepts a set screw that attaches the output line connecting terminal to the transfer bus bar, the set screw screws into the screw-hole to attach to the endplate, and the output line connecting terminal is connected to the transfer bus bar via the set screw and the endplate.

9. The battery system as cited in claim 8 wherein the endplate has a boss protrusion that allows a set screw to be screwed in for attachment, the set screw is a self-tapping set screw that can be screwed into and attached to the endplate boss protrusion, the self-tapping set screw is screwed into the boss protrusions to establish the screw-hole, and the self-tapping set screw is attached to the endplate when it is screwed into the screw-hole.

10. The battery system as cited in claim 9 wherein the self-tapping set screw is inserted through the output line connecting terminal and transfer bus bar and screwed into the boss protrusion, and the transfer bus bar and output line connecting terminal are stacked on the boss protrusion and attached to the endplate.

11. The battery system as cited in claim 1 wherein an output line connecting terminal is a round terminal having a through-hole to insert a bolt or set screw, the transfer bus bar has through-holes to insert bolts or set screws, and a bolt or set screw is inserted through a connecting terminal through-hole and a transfer bus bar through-hole to connect the output line connecting terminal to the transfer bus bar.

12. The battery system as cited in claim 1 wherein electrode terminals of the battery cells that make up a battery block are disposed at an inclined angle with respect to the battery cell electrode surface.

13. The battery system as cited in claim 12 wherein a transfer bus bar is sheet metal with the end that connects to an electrode terminal bent at an inclined angle to facilitate stacking and connection on an electrode terminal that is disposed at an inclined angle.

14. The battery system as cited in claim 2 wherein the transfer bus bar is provided with through-holes that coincide with the location of the through-hole established in the electrode terminal and with the location of the nut attached in the endplate.

15. The battery system as cited in claim 1 wherein the output line connecting terminal is stacked on top of the transfer bus bar, and the connecting terminal and transfer bus bar are attached to the endplate via a bolt or set screw inserted through them.

16. The battery system as cited in claim 1 wherein the endplate is provided with a duct-plate section that establishes cooling air ducting for forced air ventilation of battery block battery cells, and a bolt is attached to that duct-plate section.
